(19) United States
(12) Patent Application Publication
(10) Pub. No.: US 2009/0067428 A1
(43) Pub. Date: Mar. 12, 2009

(54) Apparatus, Method and Computer Program Product Providing High Performance Communication Bus Having Preferred Path Source Routing, Multi-Guarantee QoS and Resource Reservation, Management and Release

(76) Inventors: Sergey Balandin, Helsinki (FI); Michel Gillet, Helsinki (FI)

Correspondence Address: HARRINGTON & SMITH, PC, 4 RESEARCH DRIVE, Suite 202, SHELTON, CT, 06484-6212, US

(21) Appl. No.: 11/920,384

(22) PCT Filed: Jun. 7, 2006
(86) PCT No.: PCT/IB2006/001508

§ 371 Date: Nov. 13, 2007

Related U.S. Application Data
(60) Provisional application No. 60/690,719, filed on Jun. 14, 2005.

(51) Int. Cl. H04L 12/56; H04L 12/28

(52) U.S. Cl. 370/392; 370/437; 370/414

(57) ABSTRACT

Disclosed are methods, apparatus and computer program products, in accordance with exemplary embodiments of this invention, that provide a communication network having an enhanced data packet source routing procedure, that provide enhanced QoS functionality in a communication network where a first network protocol layer implements QoS with relative guaranties and best effort, while an underlying layer provides physical resource distribution between data pipes with absolute QoS guaranties, and that provide provides resource reservation, management and releasing for per flow resource management with strict/hard QoS guaranties. The communication network may employ optical and/or electrical data paths.

### TECHNICAL FIELD

The teachings in accordance with the exemplary embodiments of this invention relate generally to communication buses and architectures and, more specifically but not exclusively, relate to serial bus systems and architectures.

### BACKGROUND

An important element of many electronic systems is the communications bus that interconnects various functional modules within the system. The functional modules may be discrete modules, or they may be integrated into a common integrated circuit (IC) or chip, such as in a System-on-a-Chip (SoC) type of architecture. The communications bus in this latter case may also be routed off-chip for connecting to external functional modules and/or to another electronic system, such as an accessory device or a peripheral device.

One very advantageous type of communications bus architecture is implemented as a high speed serial bus, and is described in, for example, the following commonly assigned U.S. patent applications: Ser. No. 10/684,169, Oct. 10, 2003, “Method and Apparatus Employing Pam-5 Coding with Clock Embedded in Data Stream and Having a Transition When Data Bits Remain Unchanged”, Martti Voutilainen (US-2005-0078712-A1); Ser. No. 10/961,366, Oct. 7, 2004, “Communications Bus Having Low Latency Interrupts and Control Signals, Hotpluggability Error Detection and Recovery, Bandwidth Allocation, Network Integrity Verification, Protocol Tunneling and Discoverability Features”, Michel Gillet (WO 2005/036795 A2); Ser. No. 10/961,661, Oct. 8, 2004, “Microcontrol Architecture for a System on a Chip (SoC)”, Kim Sandstrom (WO 2005/036300 A2); and Ser. No. 11/140,424, May 27, 2005, “High Speed Serial Bus Architecture Employing Network layer Quality of Service (QoS) Management”, Michel Gillet and Sergey Balandin (PCT/IB2006/001223). The disclosures of these commonly-assigned U.S. patent applications, published U.S. patent application and corresponding International Applications are incorporated herein by reference in their entireties.

The low power, high speed serial link bus that is an element of the foregoing commonly assigned U.S. patent applications is well suited for use in portable terminals, such as communications terminals, but also has broader applicability. Advantages realized by the use of this high speed serial link bus include, but are not limited to: only a few signal lines are needed, thereby reducing the number of pins or balls on the IC package and thereby reducing cost; improved EMC immunity; an ability to replace existing buses because of inherent modularity and generality; and an ability to provide hotpluggable units that connect to the bus.

### SUMMARY OF THE EXEMPLARY EMBODIMENTS OF THIS INVENTION

In an exemplary aspect thereof the invention provides a method, a computer program product and a device operable to compose a data packet that includes a first field having a value that specifies a number of routing hops, where one value of the first field specifies that default routing of a switch is used otherwise source routing is used, and a second field the interpretation of which depends on the value of the first field such that if the first field has the one value then the content of the second field is interpreted as an address of a destination host, otherwise the content of the second field specifies a port ID for forwarding the packet within the switch; and to send the composed data packet through a communication link.

In another exemplary aspect thereof the invention provides a method, a computer program product and a device operable to implement in a first protocol layer a quality of service (QoS) having relative QoS guaranties and best effort and in an underlying second protocol layer to provide physical resource distribution between data pipes with absolute QoS guaranties, where those data flows having relative QoS guaranties and best effort are assigned to a data pipe with absolute QoS guaranties, where the second protocol layer receives traffic as a unified flow for each data pipe with absolute guaranties, and where absolute QoS guaranties are provisioned based on access division to physical resources.

In a further exemplary aspect thereof the invention provides a method, a computer program product and a device operable to provide resource reservation, management and releasing for per data flow resource management with strict/hard quality of service (QoS) guaranties by sending a channel request packet from a source to a destination via a Best Effort channel of a communication link, where the request packet comprises information to define back direction source routing, if source routing is used in the forward direction, and fields specifying requested resource quotas in forward and back directions of a channel from source to destination. In a first step along a path from the source to the destination resource reservation pre-registration is performed to register an inactive channel and define a channel connection between incoming and outgoing buffers, and in a second step on the same path back from the destination to the source a request acknowledgment packet is sent so that a switch, in response, transforms the resource reservation pre-registration to an active reservation. If the request acknowledgment packet indicates that the requested resource allocation cannot be made the switch deletes a previously made channel reservation.

In these various exemplary embodiments of this invention a communication link may be a serial link, and it may be conveyed through electrical and/or optical signal paths. In an exemplar embodiment of a device the first functional unit may be located in a first section of the device, the second functional unit may be located in a second section of the device, and an optical link may pass through a mechanism that permits movement of the first section relative to the second section. The mechanism may comprise a rotatable hinge.

### BRIEF DESCRIPTION OF THE DRAWINGS

In the attached Drawing Figures:

FIG. 1 is a block diagram of a terminal that includes two exemplary functional units that are constructed and operated in accordance with the non-limiting embodiments of this invention;

FIG. 2 shows exemplary packet fields for implementing a source routing protocol in accordance with an aspect of this invention;

FIG. 3 is an exemplary time wheel depiction of a TDMA resource division scheme used for absolute QoS guaranties provision;

FIG. 4 is an exemplary time wheel depiction of a TDMA resource division scheme used for absolute and relative QoS guaranties provision, as well as for Best Effort traffic in accordance with a further aspect of the invention;

FIG. 5 shows exemplary packet fields for implementing a per flow resource reservation sent via a Best Effort channel in accordance with another aspect of this invention; and

FIGS. 6, 7 and 8 are a side view, a top view and a top view, respectively, of exemplary terminal devices containing functional units that are coupled together by a serial bus conveyed through an optical fiber.

### DETAILED DESCRIPTION

The communications bus described in the commonly assigned U.S. patent applications referenced above may be referred to for convenience below as the serial bus or link architecture. However, the exemplary embodiments of this invention are not limited for use with this particular serial bus or link architecture, nor are they limited in use to a serial bus or link per se.

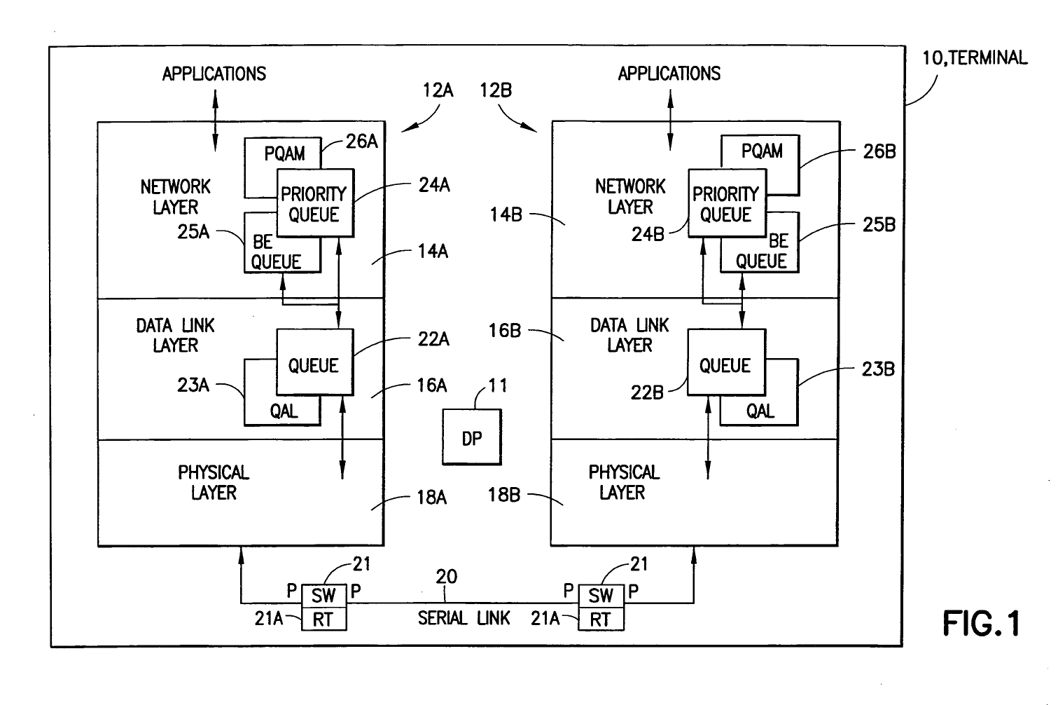

FIG. 1 is a block diagram of a terminal 10 that includes two exemplary functional units 12A, 12B that are constructed and operated in accordance with the non-limiting embodiments of this invention. In a non-limiting embodiment of the invention the terminal 10 may be a wireless communications terminal, and the functional unit 12A may comprise an application engine, control processor unit while the functional unit 12B may comprise a baseband unit. In other embodiments the terminal 10 may be a PDA, or a computer, or a digital camera, or a music player or, in general, any type of electronic device that uses a bus to communicate data between two or more constituent functional units. While only two functional units are shown in the terminal 10, there may be several, including as non-limiting examples a radio frequency (RF) unit, a memory subsystem unit, a touch screen display unit, a camera unit, and one or more accessory or peripheral units (e.g., an accessory unit that plays music based on received digital data). The functional units 12A, 12B, collectively referred to as functional units 12, are connected via a serial link 20, such as one described in the above-referenced U.S. patent application Ser. Nos. 10/684,169, 10/961,366 and 10/961,661. The serial link 20 may use multi-valued logic to encode data. It should be noted that the serial link 20 may not make a direct connection between the two functional units 12, but may instead pass through at least one router (switch) unit and/or a concentrator/distribution/switching or hub unit. FIG. 1 shows the presence of, by example, two routers or switches (SW) 21, where each may comprise an associated routing table (RT) 21A and ports (P). The presence of one or more such switches 21 is discussed below, such as in the description of the second and third exemplary aspects of this invention. In practice, switches 21 may have other functionality as well. Each functional unit 12A, 12B may include a protocol stack comprised at least of a Network layer 14A, 14B (collectively referred to as Network layers 14), a Datalink layer 16A, 16B (collectively referred to as Datalink layers 16), and a Physical layer 18A, 18B (collectively referred to as Physical layers 18), respectively. The Network layers 14 will each typically interface to higher levels, which may include one or more of Transport, Session, Presentation and Application layers.

The Open System Integration (OSI) definition of layers may be used for convenience. In this non-limiting case the Physical layer 18 transforms logic signals into electrical or other signals on the transmission medium of the serial link 20, and also transforms received signals into a logic signal. The Datalink layer 16 is used to enable point-to-point communications, and the Network layer 14 provides the ability to send information from one node of a network to another.

The various queues and queue access mechanisms 22, 23, 24, 25 and 26 shown in FIG. 1 are discussed in further detail below in conjunction with the second and third aspects of this invention.

It is noted that the functionality of the various aspects of this invention may be implemented in hardware, or in software, or as a combination of hardware and software. Thus, non-limiting embodiments of this invention may be implemented by computer software executable by one or more data processors (DP) 11 of the terminal 10, or by dedicated hardware, or by a combination of software and hardware.

In one non-limiting aspect thereof the invention provides a source routing solution that enhances the resource management flexibility of the high performance serial bus architecture. The source routing is an important element for implementing a discovery mechanism for hot-pluggable modules (those that can be inserted and removed with power applied), and at the same time it provides a technique for achieving load distribution and load balancing. Discovery of a new hot-pluggable module involves several steps that are maintained by the protocol stack. For devices without fixed static network address and/or hot-plugged devices, a mechanism is provided to access these devices (nodes) to give them a network address. Traditionally, broadcast mechanisms or such are used to address this issue. However, the complexity of introducing broadcast (and/or multicast) in this context is costly.

Further in accordance with the non-limiting embodiments of this invention an extension of the high performance serial bus architecture is provided with an advanced Quality of Service (QoS) functionality that supports, by example, three types of guaranties. Mobile device user applications have substantially different requirements on the QoS provided to their data and control flows. Many applications can be built on top of a Best Effort (BE) service model and QoS models with relative guaranties. However, some applications require hard guaranties on QoS provided to the data traffic. In order to enable a device to support all three types of QoS guaranties, the high performance serial bus architecture is provided with an extended and enhanced the QoS mechanism.

A further exemplary and non-limiting aspect of this invention pertains to resource reservation, management and releasing that allows per flow resource management with strict/hard QoS guarantees. The use of this aspect of the invention results in a significant increase in the acceptance rate for the new resource reservation requests and enhances the provision of various QoS guarantees. As the high performance serial bus architecture experiences increasing loading, such as that due to third party software, the requirements for an efficient power management technique and for strict/hard QoS guaranties provided on per channel (or per flow) basis is addressed by the aspect of the invention.

In non-limiting aspects thereof the invention provides enhanced QoS functionality for a communications bus, and may be used to advantage in the serial bus architecture that was discussed above. It should be appreciated, however, that the enhanced QoS functionality in accordance with the non-limiting embodiments of this invention may be applied to and used with other types of networks, systems and architectures, both serial and non-serial.

Further, and as described in detail below, the serial bus architecture may employ electrical connectivity between units, or it may employ optical connectivity, or it may employ a combination of optical and electrical connectivity.

By way of introduction to the first non-limiting aspect of this invention, and as was briefly noted above, the discovery of a newly attached hot-pluggable module or device involves a number of steps, which are maintained by the protocol stack 12 shown in FIG. 1. For devices without a fixed static network address and/or hot-plugged devices, a mechanism is needed to be able to access these nodes to give them a network address. Traditionally, broadcast or similar mechanisms are used to address this issue, however the complexity of introducing broadcast (and/or multicast) in the context of an enhanced serial bus architecture can be too costly. Another problem is the overload of certain network areas due to the generalized use of default network routing without multipath. A lack of load distribution and load balancing mechanisms can limit the applicability and scalability of the network. Also, in many cases an explicit setting of the traffic route is an important requirement for providing certain QoS guaranties.

The implementation of a source path routing mechanism in accordance with the first exemplary embodiment of this invention significantly simplifies discovery and enumeration of hot-pluggable modules, and also provides a simple mechanism to implement a Dynamic Host Configuration Protocol (DHCP)-like protocol, without the need to provide broadcast capabilities in the communication network. The source path routing mechanism enables addressing of the module knowing only the relative location of those ports to which hot-pluggable modules can be attached. As a consequence the devices do not need globally-unique logical addresses, which significantly reduces the design and management overhead, and also the length of address fields to be kept relatively short.

Another important advantage of the source routing mechanism is that it provides a technique to increase scalability of the communication network, and further makes it more robust in the face of dynamic changes in the network topology and/or traffic patterns. The use of the source routing mechanism is also desirable for guarantying a smooth transition to future architectures designed for networks with a high degree of interconnection. In addition, the source routing mechanism provides a technique to achieve load distribution and load balancing, which can be used to prevent network congestion and for regulating QoS provisioning in the network. For example, in certain cases the requested QoS guarantees on end-to-end delay may be achieved only when routing is performed along a specific path, and if no other traffic is following the same path. The network ability to handle exceptional events by tolerating congestion and better fulfilling QoS guaranties potentially allows one to significantly simplify and enhance the network design process.

Another advantage that results from the use of the source routing mechanism is related to security. That is, having a source path routing capability available implies that an application can force the exact route of a message, creating in essence one or more secured sub-domains along trusted routes.

Another advantage that results from the use of the source routing mechanism is the ability to combine source path routing and logical routing in the same network protocol, while maintaining an overall low implementation and operational complexity. This capability provides a choice for any protocol using the services provided by the network protocol to use either path routing or logical routing. Advantageously, the choice of the addressing mode may be made dynamically on a case by case basis.

The source (preferred path) routing in accordance with the first aspect of this invention is based on an explicit specification of the path of a data packet through the network. The path is encoded as a set of fields, where each field defines a port to be taken at a next (intermediate) switch 21. The path definition is placed, preferably but not by way of a limitation, at the beginning of the packet payload. If the packet is associated with reliable traffic (e.g., in the Transport layer header: a window field is greater than zero and the packet is not an ACK packet), then in front of the packet payload is also provided a backward source path, following the same encoding rule.

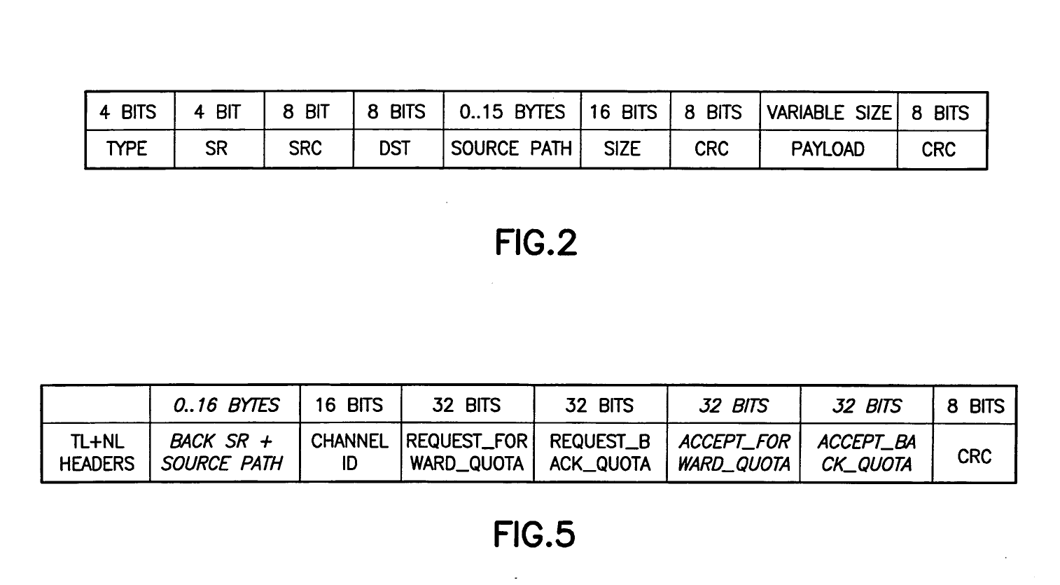

Implementation of the source routing mechanism is accomplished using a small modification of the Network layer 14 packet header and in the packet forwarding procedure. An exemplary packet with the modified Network layer 14 header has the following format shown in FIG. 2.

The various packet fields shown in FIG. 2 are defined as follows:

The type field is used for defining a type of Network layer 14 processing of the packet, and has no strict binding with the selected routing scheme (e.g., the same type may be used with the default routing and source routing).

The SR field specifies a number of routing hops in the source (preferred path) routing. If SR=0 then default switch 21 routing is used, otherwise the source routing is used. The SRC field specifies an address of the packet source node (and does not depend on the routing scheme).

The interpretation of the DST field depends on the value of the SR flag. If SR=0 then DST is an address of a destination host, otherwise DST specifies a port ID for forwarding the packet within the switch (router) 21.

The source path portion of the packet header is optional (size varies between 0 and 15 bytes), and is defined when source routing is used (SR>0).

The packet contains two CRC fields: the first protects the header information just described, and the second protects the packet payload. In the case of source routing, the first CRC value is recalculated at each intermediate router.

The packet forwarding procedure is as follows. A forwarding direction for the packets with source route encoding is defined by the value of DST field. Before forwarding the packet to the next outgoing port the DST field is updated. If the SR field is greater than one then SR is decremented by one and the DST field is removed, so that the first byte of the payload becomes the DST, otherwise the SR and DST fields are set to zero. When a node receives a packet where both the SR and DST fields are set to zero, it means that the current node is the packet destination.

In this manner the packet routing is encoded in a relative way (as it depends on the source location in the network), without using the logical address of the final destination. That is, the destination node may be one that is not registered with a logical address in the intermediate switch 21 routing tables 21A.

The source packet routing scheme in accordance with this non-limiting embodiment of the invention also permits the use of mixed routing, where for the first N hops (where N is in a range of, as a non-limiting example, 0 to 15) the packet is routed using source path routing, followed by some other type of routing (e.g., default routing). This mode of operation is possible in this non-limiting example as the maximum value for the SR field is 15 (4 bits) and the source route may contain up to 16 entries (DST+15 additional entries). Thus, the path may be encoded such that the last record represents the default logical routing starting from the location to which it is delivered using the source routing. This feature may provide a number of potentially valuable inter-systems routing options.

For node enumeration/discovery at power up, source path routing may be used to determine if every node has a network address, and if this is discovered to not be the case a given protocol can be used to provide a network address. The source path routing can also be employed by protocols to identify and discover the capabilities of nodes in the network. The same source path routing mechanism can be used when a device is hot-plugged into the network.

On a more general note, by combining source path routing and logical addressing, any protocol defined and using the services provided by the Network layer 14 can be used, and can follow different routes in the network than routes defined by routing tables based on logical addressing.

This important property provides the possibility to use the advantages of cyclic topologies in the network, while using a routing algorithm for acyclic topologies, to maintain the complexity of the routing algorithms relatively low. In other words, source path routing gives a very simple means to build a logical acyclic span tree on a physically cyclic network.

The techniques described above in accordance with this non-limiting embodiment of the invention can be used with a number of different network architectures. As one non-limiting example, the source routing scheme discussed above may be used in Spacewire-based systems (SpW, see http://www.estec.esa.nl/tech/spacewire/). Further, the source path routing scheme may be applied to optically-based communication networks.

Discussing now in greater detail the second non-limiting embodiment of this invention, it is noted that user applications for mobile devices have substantially different requirements on the quality of service provided to their data and control flows. Many such applications can be built on top of the Best Effort service model and on the QoS service model with relative guaranties. However, some applications require hard guaranties on QoS to be provided to the data traffic. In order to enable a device to support all three types of QoS guaranties, the network architecture is further enhanced with the QoS mechanism discussed below.

One QoS subsystem related to the network architecture implements most of the QoS management functionality on the Datalink layer 16 by performing bandwidth allocation, an approach that may in some cases increase the complexity of both the underlying logic and implementation.

For example, and as described in U.S. patent application Ser. No. 10/961,366, the communications bus protocol permits for the allocation of bandwidth, where data sent or received by the Datalink layer is divided into frames, where a frame represents a total amount of bandwidth available at a given time, and where each frame is divided into channels, and a number of bytes allocated to a channel represents a percentage of the frame that can be used by a given channel. The bandwidth allocation procedures are preferably based on counting the number of bytes sent in a channel within a given frame, and if the number of bytes equals or exceeds the number of bytes allowed by the frame percentage of the channel, no further data is sent on this particular channel during the current frame. The channels may be divided into cells of a fixed size, and in a frame all cells can be intermixed regardless of the channel from which they originated.

The QoS enhancement that is a feature of this invention is based at least in part on a Datalink layer 16 extension of the serial bus architecture.

The improved network architecture described in the above-referenced U.S. patent application Ser. No. 11/140,424, filed May 27, 2005, “High Speed Serial Bus Architecture Employing Network layer Quality of Service (QoS) Management”, Michel Gillet and Sergey Balandin, provides QoS guaranties by performing traffic scheduling using at least in part extensions to the Network layer 14.

An analysis of the entire set of user traffic requirements specified for mobile device applications has resulted in an identification of the following three (non-limiting) types of QoS guaranties: absolute guaranties, relative guaranties, and best effort (BE). A previous solution provides one of absolute or relative QoS guaranties at any given time, but not both at the same time. This aspect of the invention provides an enhanced QoS mechanism that takes the best elements of earlier QoS extensions and further extends them in order to deliver the absolute and relative QoS guaranties with but a marginal increase of the system complexity.

This aspect of the invention may be used to advantage with advanced mobile devices (with increased logical complexity), where all three types of QoS guaranties for user applications can be maintained.

This aspect of the invention implements QoS functionality in the communication network and in the Datalink layers 16. As an example, the Network layer 14 may be used to implements QoS with relative guaranties and best effort, while the Datalink layer 16 is responsible for providing physical resource distribution between pipes with absolute guaranties, where the flows with relative QoS guaranties and best effort are assigned to one of the pipes with absolute QoS guaranties.

The Datalink layer 16 receives traffic as a unified flow for each pipe with absolute guaranties. Depending on the resource sharing mechanism implementation, the traffic may be delivered from upper layers via logically separated buffers, when the parallel access to flows is needed, e.g. for FDMA, or by using a single buffer and special scheduling scheme, e.g., for TDMA.

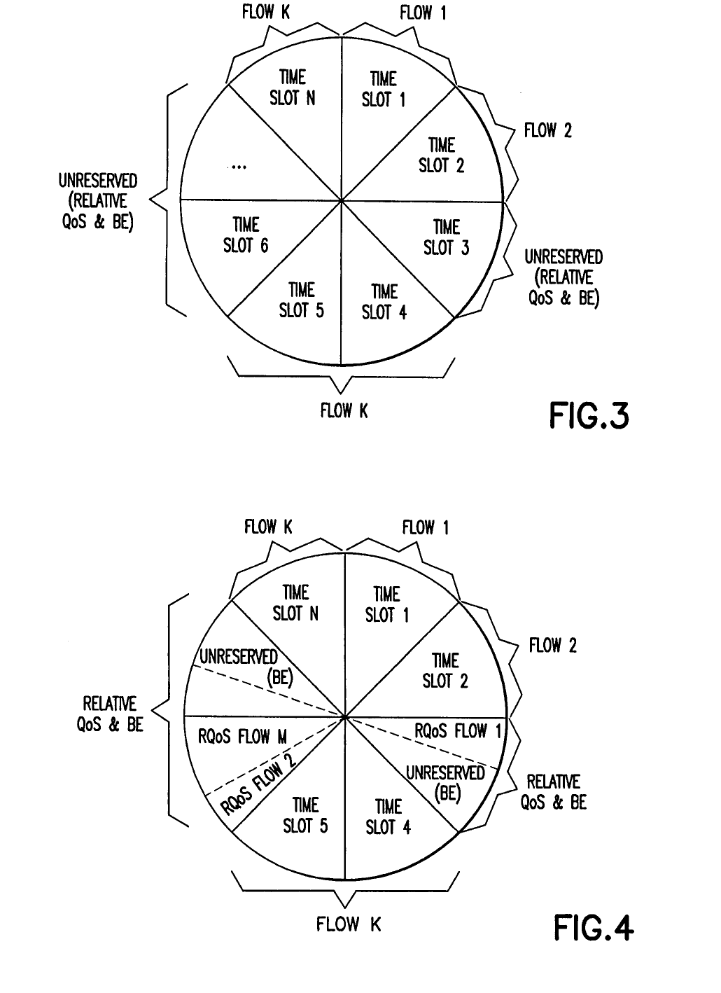

Provision of the absolute QoS guaranties is based on access division to physical resources. An example, which may be referred to as a time-wheel, of a Time-Division Multiple Access (TDMA) resource division scheme used for absolute QoS guaranties provision is shown in FIG. 3.

Output time-wheels may be synchronized to input time-wheels in order to define explicit temporal precedence rules between input bus time slots and output bus time slots. The observation of the temporal precedence rule between time slots is important in order to reduce buffer size in switches.

However, to achieve synchrony maintaining the phase difference of the output and input time-wheels below a given constrain is not the only possibility. In practice, it may be sufficient to maintain the phase difference constant within a given constraint. In both cases, the given constraint may be viewed as an indirect measure of the amount of buffers needed in a switch 21.

Typically, all time slots have an identical size in such a scheme, but this restriction is in no way related to the scheme itself, but is merely a simplification to reduce its complexity.

To define the more generic case of time slots having different sizes it is desirable to ensure that every output time slot of a given logical pipe is scheduled chronologically after the corresponding input time slot(s). Since the time slot size is variable, a procedure is needed to identify and define the temporal location of the start of each time slot during the QoS reservation mechanism. If the input and output time-wheels have their phase synchronized, it becomes straightforward to ensure the precedence rules for time slots by simply using the temporal position of a time slot in a time-wheel, since this position has a global meaning. If the time-wheels are synchronized by maintaining their phase difference constant, the temporal position of a time slot in a time-wheel no longer has a global meaning, but only a relative meaning, and the phase difference between the input and output time-wheels has then to be taken into account.

Determining whether the time-wheels are phase synchronized or phase constant is thus an important consideration. Phase synchronized time-wheels implies the use of a handshake protocol, which introduces transient states in the system to reach synchronism when a time-wheel is re-started after being stopped. Maintaining the phase constant does not require a handshake protocol, but the algorithm to insure the precedence rules of time slots is a bit more difficult as the temporal position of a time slot no longer has a global meaning.

To simplify the algorithm to insure the precedence rules of time slots, this aspect of the invention introduces the concept of temporal time slots which all have an equal atomic size and which are used to insure the precedence rules by providing a metric to measure the start and end of a logical time slot, as well as logical time slots which have variable size and are used to define the QoS configuration.

All output time-wheels of a switch 21 are assumed to be phase synchronized, since all are based on an internal clock of the switch. One may then consider that there is one master time-wheel per switch 21 used to derive all output time-wheels. A switch 21 need not have input time-wheels, and an input time-wheel may refer to the output time-wheel of a previous hop.

A network routing switch 21 may monitor the start of an input time-wheel and measure it using its master time-wheel. This measurement is an estimate of the phase difference and is used to keep the phase difference constant and, by a reservation mechanism, to ensure the precedence rules are adhered to.

The packet traffic with relative QoS and Best Effort guaranties is fitted to a logical pipe that is built on top of the physical pipes, which are those remaining after assignment of the flows with absolute QoS guaranties. As such, the size of the logical pipe may changeover the time from the minimal size defined in the QoS configuration, to the maximal available to a link when there are no flows with absolute guaranties.

Relative QoS and Best Effort Guaranties Provision Mechanism

The resource sharing between flows with relative QoS guaranties and Best Effort flows is performed by a buffer access scheduling mechanism implemented within, preferably, the Network layer 14. For this purpose the Network layer 14 is extended with an additional queue for QoS traffic, referred to in FIG. 1 as a priority queue 24, which is used as a temporary storage for the QoS traffic before it is transferred to a next hop (e.g., to a next router or switch) in the communication network. Associated with priority queue 24 is a priority queues access manager or mechanism (PQAM) 26.

The PQAM 26 operates in scheduling of the QoS flows. The scheduling mechanism supports two types of QoS reservations: per-flow and per-packet reservations. The per-flow reservation is performed when an application requires continuous quality guaranties for a certain time, and makes the QoS reservation before creation of the data flow. The per-packet reservation is used when guaranties are needed only for a given data packet. The traffic with per-packet reservation has higher priority than BE traffic, which may be accommodated by a BE queue or buffer 25. The delivered packets are guarantied to fulfill QoS requirements, but delivery itself is not guarantied. The link accepts a packet for transmission only if it has sufficient unreserved resources to accommodate the packet. The example of the TDMA resources access division scheme, which supports the relative QoS and Best Effort guaranties, is presented in FIG. 3.

The relative QoS guaranties provision schemes are implemented using the same Network layer 14 PQAM 26. For the BE traffic the Network layer 14 has the additional logically separated BE queue 25. In addition, Datalink layer 16 queue 22 access logic (QAL) 23 may be formulated as follows: if the outbound Datalink buffer 22 has free space, first take data from the Network layer 14 QoS queue 24, and only if it is empty, take data from the Network layer 14 BE queue 25.

The QoS provided to the flow is always not less than the QoS that was requested. When the flow demands more than was reserved, the additional value is provided only if there are unreserved resources.

It can be noted that the use of the common Datalink layer Queue 22, and the logically independent treatment of the QoS and BE traffic at the Network layer 12 via the Network layer Priority Queue 24 and the BE Queue 25, could potentially lead to a logical link blocking condition. For example, the link 20 could become logically blocked when the Network layer BE Queue 24 is full, and the inbound (from the Physical layer 16) Datalink layer Queue 22 contains a BE packet. The link could potentially remain blocked for some time, as the presence of QoS traffic (e.g., coming from another link) could result in the BE traffic not being served. Such a scenario is undesirable as it can degrade the requested QoS guaranties.

In order to prevent an occurrence of link blocking the flow control procedure uses Flow Control Tokens (FCTs) for permitting the transfer of a certain amount of data from the Datalink outbound Queue 22 on one end of the link 20 to the Datalink inbound Queue 22 at the other end of the link 20. One procedure advertises the total length of the inbound Datalink buffer. In accordance with an aspect of the teachings of this invention a modified procedure introduces a threshold value that specifies a number of FCTs advertised to the sender. If sender receives more advertisements than the threshold value, both QoS and BE packets are allowed to enter the link 20. Otherwise, only the QoS traffic is allowed to be placed into the outbound Datalink layer Queue 22. The receiver sends more than the threshold number of advertisements only if the corresponding incoming Network layer BE Queue 25 has free space. For example, assume that the total length of the incoming Network layer BE Queue 25 is 10 words, and assume further that the receiver sets the threshold value to be seven words. In this example the receiver can send up to seven FCTs, when the BE Queue 25 is full, and more than seven if there is a place for the corresponding one to three packets in the corresponding BE Queue 25. In one non-limiting embodiment the FCTs are sent by the QAL 23 in FIG. 1 and thus originate in the Datalink layer 16.

Taking into account the foregoing modification of the flow control procedure the Datalink layer Queue 22 access logic 23 operates as follows: if the outbound Datalink Queue 22 has free space, first accept data from the Network layer QoS Priority Queue 24, and only if the Network layer QoS Priority Queue 24 is empty, and the number of received FCT advertisements exceeds the defined threshold, accept data from the Network layer BE Queue 25.

The techniques described above in accordance with non-limiting embodiments of the invention can also be used with a number of different bus and network architectures, such as the Spacewire-based systems referenced above, as well as with optically-based communication systems.

It should further be appreciated that some elements of the serial link management logic may be moved from the Network layer 12 to the Datalink layer 14, if it provides a more efficient implementation.

Turning now to the third aspect of this invention, that is, to the aspect concerned with resource reservation, management and releasing that enables performing per flow resource management with strict/hard QoS guaranties, there is provided an improved increase of the acceptance rate for new resource reservation requests. This aspect of the invention improves on other types of attempted solutions, such as a specified application domain using a per traffic class relative prioritization mechanism.

This aspect of the invention defines an efficient mechanism for performing per flow resource reservation. It may be used in place of per traffic class guaranties, where each flow belonging to a certain class has only some relative guaranties compared to the flows of another classes, and no guaranties relative to the other flows of the same class. This aspect of the invention significantly increases the acceptance rate of new channel reservations as compared to a simple budgeting reservation principle, that may be viewed as the most straightforward for the specified application domain, and furthermore enables more efficient power management in the network to be realized.

In accordance with an exemplary embodiment the traffic originator (source) sends an isochronous (ISOC) channel request packet to the destination. The request for a channel packet is sent via the Best Effort channel. The packet has the exemplary format shown in FIG. 5. The packet may have standard Transport layer and Network layer 14 headers, which are followed by an optional section that defines back direction source routing, if source routing was used in the forward direction. A next field is the source-unique ID of the flow, which together with SRC address form a network-wide unique channel ID. The following two fields are requested resource quotas in forward and back directions of the channel from source to destination. The next two 32-bit fields are optional, and represent amounts of resources that are acceptable in forward and back channel directions, and may be viewed as a lower bound of the acceptable resources, where the values are less than or equal to the requested quotas in the previous two fields.

The resource reservation is performed in two steps. When the request packet is traveling in a forward direction it makes a resource pre-reservation, which registers an inactive channel and defines a channel connection between incoming and outgoing buffers. This first step (reservation pre-registration) prevents an occurrence of a resource reservation for uncompleted requests which may result from a lack of downstream resources or from a loss of the request packet. If the requested quota cannot be allocated, the accepted quota is defined and if the available resources exceed the accepted quota, then the requested quota is set equal to the amount of available resources. The destination host acknowledges the request packet with a packet of the same format, where the type field is set to ACK (acknowledgment). At this point the second step of the resource allocation begins. The ACK packet is forwarded using the same path back to the source. When an intermediate switch 21 receives the acknowledgment packet, it transforms the resource pre-reservation made on the forward path of the request packet to an active reservation for the given channel ID.

If the requested quota cannot be allocated, the accepted quota is undefined, or the accepted quota exceeds the available resources, then the request is defined as unfulfilled and the switch generates a request acknowledgment with both request quota fields set to zero. When a switch 21 receives a request acknowledgment packet with both request quotas set to zero, it deletes the corresponding channel reservation.

If the requested quota (or the acceptable quota) can be allocated based on active reservations, but cannot be allocated when the pre-reservations are taken into account, then the switch acknowledges the request packet by a NACK (not acknowledged packet). When a switch receives a NACK packet, it deletes the pre-reservation for the given channel, but if the channel already has an active reservation, that reservation is not modified. The source uses the receipt of a NACK packet as a signal that the reservation request for the given channel cannot be fulfilled at the current time.

The QoS request packet may be also used for modifying settings of an existing reservation. The reservation procedure is similar to the case of the new channel reservation, with e only significant difference being that in case of an unfulfilled request, the switch 21 generates a NACK instead of an ACK packet.

If the request packet or acknowledgment is lost (or corrupted) the source host waits for a timeout (e.g., a maximum network round trip time) and re-sends the request packet. The new request packet takes the same path until it reaches the destination, or until it reaches a switch 21 where the reserved quota is equal to the requested quota for a given channel ID.

The request packet and the acknowledgment packet are preferably forwarded along a Best Effort default path, if it is guarantied that the BE default path is the same in both directions. Otherwise, it is preferred that the above-described source routing (predefined path) be used.

The resource release procedure is implemented using the same request packet, where the requested quotas in both directions are set to zero.

The techniques described above in accordance with this further non-limiting embodiment of the invention may also be used with a number of different bus and network architectures, such as the Spacewire-based systems referenced above, and also with the Internet and other network protocol types.

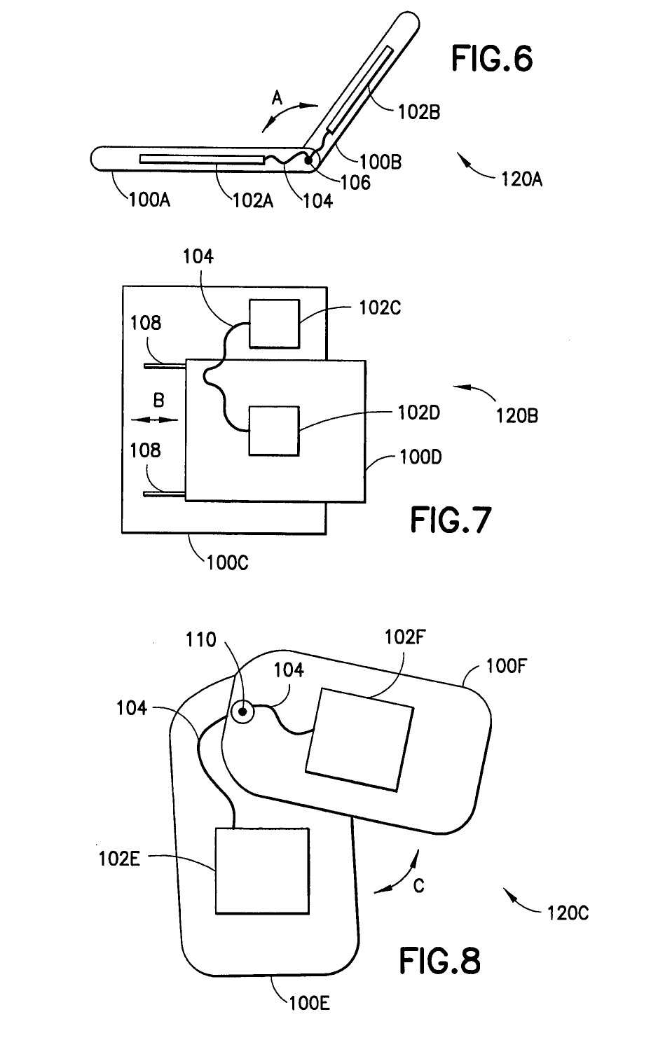

Further in this regard, and referring to FIGS. 6, 7 and 8, there are shown various illustrious and non-limiting embodiments of devices 120A, 120B and 120C, respectively, such as mobile communication devices, that include an optical fiber 104 through which the serial link 20 of FIG. 1 is conveyed in whole or in part. In the illustrated embodiments of FIGS. 6, 7 and 8 the device 120 is partitioned into at least two sections, including a base section 100A, 100C and 100E, and a second, moveable section 100B, 100D, 100E, respectively, Each section is assumed to include at least one functional unit 102A, 102B (for the embodiment of FIG. 6), 102C, 102D (for the embodiment of FIG. 7), and 102E, 102F (for the embodiment of FIG. 8), that communication via the serial bus 20 that is conveyed through the optical fiber 104. A pair of functional units (e.g., 102A, 102B) may correspond to the functional units 12A, 12B shown in FIG. 1. As was noted above, one of the functional units may comprise an application engine, control processor unit while the other functional unit may comprise a baseband unit. It is also within the scope of the exemplary embodiments of this invention for one of the functional units to comprise a user interface-related functional unit, such as a display, or a user input device such as a keypad or keyboard. It is also within the scope of the exemplary embodiments of this invention for one of the functional units to comprise a digital camera module, or a mass storage device, or a or a high quality audio replication module, as two non-limiting examples.

In the non-limiting embodiments shown in FIGS. 6, 7 and 8 movement between the first, base unit and the second, moveable unit may be as indicated by the arrows A, B and C, respectively. For example, in the device 120A a pair of hinges 106 (only one being shown) may be used to provide rotation along the arrow A, in the device 120B a slide mechanism 108 may be used to provide lateral movement along the arrow B, and in the device 120C a single hinge (disposed orthogonal to the major surfaces of base unit 100E and moveable unit 100F) may be used to provide rotation along the arrow C.

In other embodiments of the invention rotation with three degrees of freedom may be provided. In addition, in other embodiments of the invention the device 120 may be constructed as a single unit, without rotational and/or lateral movement being possible.

In the illustrated embodiments the optical fiber 104 is shown as running in a continuous fashion between the two functional units. However, in other embodiments one or more pairs of optical transmitters (e.g., LEDs) and optical receivers (e.g., photodiodes) may be used to convey the optical signals between the base unit 100A, 100C, 100E and the moveable unit 100B, 100D, 100F, respectively, such as through a rotatable hinge or other mechanism that permits movement of the first unit relative to the second unit. As such, it should be appreciated that at least part of the optical path may be a free-space path, and not one that passes through an optical conduit per se.

In view of the foregoing description, it can be appreciated that disclosed herein is a method, apparatus and computer program product, in accordance with an exemplary embodiment of this invention, that provide a data packet source routing procedure wherein a packet includes a SR field that specifies a number of routing hops, where if SR=0 then default switch routing is used, otherwise source routing is used, a DST field the interpretation of which depends on the state of the SR field such that if SR=0 then DST is an address of a destination host, otherwise DST specifies a port ID for forwarding the packet within the switch, an optional source path field and first and second data integrity fields where the first protects at least the fields just described, and the second protects the packet payload, where the first integrity value is recalculated at each intermediate switch. During packet routing a forwarding direction for the packet with source routing is defined by the value of DST field, where before forwarding the packet to the next outgoing port the DST field is updated, if the SR field is greater than one then SR is decremented by one and the DST field is removed, so that the first byte of the payload becomes the DST, otherwise the SR and DST fields are set to zero. When a node receives a packet where both the SR and DST fields are set to zero, it means that the current node is the packet destination. Logical routing may then also be employed.

Also disclosed herein is a method, apparatus and computer program product, in accordance with a further exemplary embodiment of this invention, that provide a QoS functionality in a communication network where a Network layer implements QoS with relative guaranties and best effort, while an underlying Datalink layer provides physical resource distribution between pipes with absolute QoS guaranties, where the flows with relative QoS guaranties and best effort are assigned to one of the pipes with absolute QoS guaranties, and where the Datalink layer receives traffic as a unified flow for each pipe with absolute guaranties, and where absolute QoS guaranties are provisioned based on access division to physical resources.

Also disclosed herein is a method, apparatus and computer program product, in accordance with another exemplary embodiment of this invention, that provides resource reservation, management and releasing for per flow resource management with strict/hard QoS guaranties, where a source sends a channel request packet to a destination via a Best Effort channel, the request packet comprising defines back direction source routing, if source routing is used in the forward direction, fields specifying requested resource quotas in forward and back directions of the channel from source to destination, and optional fields specifying amounts of resources that are acceptable in forward and back channel directions having values less than or equal to the requested resource quotas, where in a first step along the path from source to destination resource reservation pre-registration is performed, which registers an inactive channel and defines a channel connection between incoming and outgoing buffers, and in a second step on the same path back from the destination to the source a request acknowledgment packet is sent so that a network switch 21, in response, transforms the resource reservation pre-registration to an active reservation, else if the request acknowledgment packet indicates that the requested resource allocation cannot be made the switch 21 deletes a previously made channel reservation.

In all of these various exemplary embodiments the communications may be conveyed within and between functional units through one or more wires, cables and/or optical fibers. It is also within the scope of the exemplary embodiments to convey the communications wirelessly, such as by the use low power RF or optical signals (e.g., via a Bluetooth™ connection).

It should be appreciated that the functional units 12A, 12B, including any circuitry operable for implementing the exemplary embodiments of this invention, may be embodied in one or more integrated circuits, modules and/or other types of devices.

The foregoing description has provided by way of exemplary and non-limiting examples a full and informative description of the exemplary embodiments of this invention. However, various modifications and adaptations may become apparent to those skilled in the relevant arts in view of the foregoing description, when read in conjunction with the accompanying drawings. As but some examples, the use of other similar or equivalent message types, message fields and the order of the fields in the packet may be attempted by those skilled in the art. Further, the two or more functional units, such as the units 12A, 12B, need not be contained within the same package. For example, one functional unit may be an add-on accessory that is mechanically and/or electrically/optically coupled to the terminal 10. Further, the communication link 20 may use multi-valued logic levels, or binary logic levels, or any suitable format for encoding, representing and sending data. Further, the data sent through the communication link 20 may be self-clocking, or a separate synchronizing clock may be employed. However, all such and similar modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
composing a data packet that includes a first field having a value that specifies a number of routing hops, where one value of the first field specifies that default routing of a switch is used otherwise source routing is used, and a second field the interpretation of which depends on the value of the first field such that if the first field has the one value then the content of the second field is interpreted as an address of a destination host, otherwise the content of the second field specifies a port ID for forwarding the packet within the switch; and
sending the composed data packet through a communication link.

2. The method of claim 1, where the communication link is comprised of a serial link.

3. The method of claim 1, where the communication link is comprised of an optical link.

4. The method of claim 1, where composing further comprises providing first and second data integrity fields where the first data integrity field protects at least the first and second fields and the second data integrity field protects a payload of the data packet, where the first integrity value is recalculated at an intermediate switch.

5. The method of claim 1, where during data packet routing a forwarding direction for the data packet with source routing is defined by the value of the second field, where before forwarding the data packet to a next outgoing port the second field is updated.

6. The method of claim 5, where if the value of the first field is greater than one then the first field is decremented by one and the second field is removed, so that the first byte of a payload of the data packet is interpreted as the second field, otherwise the values of the first and second fields are set to zero for indicating that a node receiving the data packet is the destination node for the data packet.

7. A computer program product embodied on a computer-readable medium, comprising program instructions the execution of which result in operations that comprise:
composing a data packet that includes a first field having a value that specifies a number of routing hops, where one value of the first field specifies that default routing of a switch is used otherwise source routing is used, and a second field the interpretation of which depends on the value of the first field such that if the first field has the one value then the content of the second field is interpreted as an address of a destination host, otherwise the content of the second field specifies a port ID for forwarding the packet within the switch; and
sending the composed data packet through a communication link.

8. The computer program product of claim 7, where the communication link is comprised of a serial link.

9. The computer program product of claim 7, where the communication link is comprised of an optical link.

10. The computer program product of claim 7, where the operation of composing further comprises providing first and second data integrity fields where the first data integrity field protects at least the first and second fields and the second data integrity field protects a payload of the data packet, where the first integrity value is recalculated at an intermediate switch.

11. The computer program product of claim 7, where during data packet routing a forwarding direction for the data packet with source routing is defined by the value of the second field, where before forwarding the data packet to a next outgoing port the second field is updated.

12. The computer program product of claim 11, where if the value of the first field is greater than one then the first field is decremented by one and the second field is removed, so that the first byte of a payload of the data packet is interpreted as the second field, otherwise the values of the first and second fields are set to zero for indicating that a node receiving the data packet is the destination node for the data packet.

13. A device comprising:
a first functional unit to compose a data packet that includes a first field having a value that specifies a number of routing hops, where one value of the first field specifies that default routing of a switch is used otherwise source routing is used, and a second field the interpretation of which depends on the value of the first field such that if the first field has the one value then the content of the second field is interpreted as an address of a destination host, otherwise the content of the second field specifies a port ID for forwarding the packet within the switch; and
a communication link coupled to an output of the first functional unit for conveying the composed data packet to a second functional unit.

14. The device of claim 13, where the communication link is comprised of a serial link.

15. The device of claim 13, where the communication link is comprised of an optical link.

16. The device of claim 15, where the first functional unit is located in a first section of the device, where the second functional unit is located in a second section of the device, and where the optical link passes through a mechanism that permits movement of the first section relative to the second section.

17. The device of claim 16, where the mechanism comprises a rotatable hinge.

18. The device of claim 13, where said first functional unit provides first and second data integrity fields where the first data integrity field protects at least the first and second fields and the second data integrity field protects a payload of the data packet, where the first integrity value is recalculated at an intermediate switch.

19. The device of claim 13, where during data packet routing a forwarding direction for the data packet with source routing is defined by the value of the second field, where before forwarding the data packet to a next outgoing port the second field is updated.

20. The device of claim 13, where if the value of the first field is greater than one then the first field is decremented by one and the second field is removed, so that the first byte of a payload of the data packet is interpreted as the second field, otherwise the values of the first and second fields are set to zero for indicating that a node receiving the data packet is the destination node for the data packet.

21. A method, comprising:
implementing in a first protocol layer a quality of service (QoS) having relative QoS guaranties and best effort; and
in an underlying second protocol layer, providing physical resource distribution between data pipes with absolute QoS guaranties, where those data flows having relative QoS guaranties and best effort are assigned to a data pipe with absolute QoS guaranties, where the second protocol layer receives traffic as a unified flow for each data pipe with absolute guaranties, where absolute QoS guaranties are provisioned based on access division to physical resources.

22. The method of claim 21, where a communication link through which the data pipes are conveyed between functional units is comprised of a serial link.

23. The method of claim 21, where a communication link through which the data pipes are conveyed between functional units is comprised of an optical link.

24. The method of claim 21, where the first protocol layer comprises a Network layer, and where the second protocol layer comprises a Datalink layer.

25. A computer program product embodied on a computer-readable medium, comprising program instructions the execution of which result in operations that comprise:
implementing in a first protocol layer a quality of service (QoS) having relative QoS guaranties and best effort; and
in an underlying second protocol layer, providing physical resource distribution between data pipes with absolute QoS guaranties, where those data flows having relative QoS guaranties and best effort are assigned to a data pipe with absolute QoS guaranties, and where the second protocol layer receives traffic as a unified flow for each data pipe with absolute guaranties, where absolute QoS guaranties are provisioned based on access division to physical resources.

26. The computer program product of claim 25, where a communication link through which the data pipes are conveyed between functional units is comprised of a serial link.

27. The computer program product of claim 25, where a communication link through which the data pipes are conveyed between functional units is comprised of an optical link.

28. The computer program product of claim 25, where the first protocol layer comprises a Network layer, and where the second protocol layer comprises a Datalink layer.

29. A device, comprising:
a first functional unit comprising a first protocol layer implementing a quality of service (QoS) having relative QoS guaranties and best effort and an underlying second protocol layer providing physical resource distribution between data pipes with absolute QoS guaranties, where those data flows having relative QoS guaranties and best effort are assigned to a data pipe with absolute QoS guaranties, and where the second protocol layer receives data traffic as a unified flow for each data pipe with absolute guaranties, where absolute QoS guaranties are provisioned based on access division to physical resources; and
a communication link coupled to an output of the second functional unit for conveying data traffic to a second functional unit.

30. The device of claim 29, where the communication link is comprised of a serial link.

31. The device of claim 29, where the communication link is comprised of an optical link.

32. The device of claim 31, where the first functional unit is located in a first section of the device, where the second functional unit is located in a second section of the device, and where the optical link passes through a mechanism that permits movement of the first section relative to the second section.

33. The device of claim 32, where the mechanism comprises a rotatable hinge.

34. The device of claim 29, where the first protocol layer comprises a Network layer, and where the second protocol layer comprises a Datalink layer.

35. A method, comprising:
providing resource reservation, management and releasing for per data flow resource management with strict/hard quality of service (QoS) guaranties, by
sending a channel request packet from a source to a destination via a Best Effort channel of a communication link, the request packet comprising information to define back direction source routing, if source routing is used in the forward direction, and fields specifying requested resource quotas in forward and back directions of a channel from source to destination, where
in a first step along a path from the source to the destination resource reservation pre-registration is performed to register an inactive channel and define a channel connection between incoming and outgoing buffers, and
in a second step on the same path back from the destination to the source a request acknowledgment packet is sent so that a switch, in response, transforms the resource reservation pre-registration to an active reservation, else if the request acknowledgment packet indicates that the requested resource allocation cannot be made the switch deletes a previously made channel reservation.

36. The method of claim 35, further comprising specifying amounts of resources that are acceptable in forward and back channel directions having values less than or equal to the requested resource quotas.

37. The method of claim 35, where the communication link is comprised of a serial link.

38. The method of claim 35, where the communication link is comprised of an optical link.

39. A computer program product embodied on a computer-readable medium, comprising program instructions the execution of which result in operations that comprise:
providing resource reservation, management and releasing for per data flow resource management with strict/hard quality of service (QoS) guaranties, by
sending a channel request packet from a source to a destination via a Best Effort channel of a communication link, the request packet comprising information to define back direction source routing, if source routing is used in the forward direction, and fields specifying requested resource quotas in forward and back directions of a channel from source to destination, where
in a first step along a path from the source to the destination resource reservation pre-registration is performed to register an inactive channel and define a channel connection between incoming and outgoing buffers, and
in a second step on the same path back from the destination to the source a request acknowledgment packet is sent so that a switch, in response, transforms the resource reservation pre-registration to an active reservation, else if the request acknowledgment packet indicates that the requested resource allocation cannot be made the switch deletes a previously made channel reservation.

40. The computer program product of claim 39, further comprising specifying amounts of resources that are acceptable in forward and back channel directions having values less than or equal to the requested resource quotas.

41. The computer program product of claim 39, where the communication link is comprised of a serial link.

42. The computer program product of claim 39, where the communication link is comprised of an optical link.

43. A device, comprising:
a first functional unit coupled to a second functional unit via a communications link; and
means for providing resource reservation, management and releasing for per data flow resource management with strict/hard quality of service (QoS) guaranties, by sending a channel request packet from a source functional unit to a destination functional unit via a Best Effort channel of the communication link, the request packet comprising information to define back direction source routing, if source routing is used in the forward direction, and fields specifying requested resource quotas in forward and back directions of a channel from source to destination, where in a first step along a path from the source functional unit to the destination functional unit resource reservation pre-registration is performed to register an inactive channel and define a channel connection between incoming and outgoing buffers, and in a second step on the same path back from the destination functional unit to the source functional unit a request acknowledgment packet is sent so that a switch, in response, transforms the resource reservation pre-registration to an active reservation, else if the request acknowledgment packet indicates that the requested resource allocation cannot be made the switch deletes a previously made channel reservation.

44. The device claim 43, said providing means further operable to specify amounts of resources that are acceptable in forward and back channel directions having values less than or equal to the requested resource quotas.

45. The device of claim 43, where the communication link is comprised of a serial link.

46. The device of claim 43, where the communication link is comprised of an optical link.

47. The device of claim 46, where the first functional unit is located in a first section of the device, where the second functional unit is located in a second section of the device, and where the optical link passes through a mechanism that permits movement of the first section relative to the second section.

48. The device of claim 47, where the mechanism comprises a rotatable hinge.
